(19) United States
(12) Patent Application Publication
(10) Pub. No.: US 2025/0038467 A1
(43) Pub. Date: Jan. 30, 2025

(54) CONNECTOR

(71) Applicant: SUMITOMO WIRING SYSTEMS, LTD., Mie (JP)

(72) Inventors: Yoichi TAKAGI, Mie (JP); Toshihiro ITO, Mie (JP); Tsuyoshi MASE, Mie (JP); Takahiro KIKUCHI, Mie (JP); Sho KOBAYASHI, Mie (JP); Toya TAICHI, Mie (JP)

(21) Appl. No.: 18/765,852

(22) Filed: Jul. 8, 2024

(30) Foreign Application Priority Data
Jul. 24, 2023 (JP) 2023-119853

(51) Int. Cl. H01R 31/08; H01R 13/70

(52) U.S. Cl. CPC H01R 31/08; H01R 13/70

(57) ABSTRACT

A connector includes a first housing and a second housing, a plurality of first terminals to be disposed in the first housing, and at least one shorting terminal to be disposed in the first housing. The shorting terminal includes a pair of contact pieces for shorting a pair of the first terminals, out of the plurality of first terminals, by resiliently contacting the pair of first terminals. The second housing includes a releasing projection projecting in a connection direction to the first housing. The releasing projection includes a releasing portion for releasing a short circuit of the pair of first terminals by resiliently deforming one of the pair of contact pieces toward one side in a first direction when the first and second housings, are properly connected, and extending portions extending toward both sides in a second direction substantially orthogonal to the first direction from the releasing portion.

### CROSS-REFERENCE TO RELATED APPLICATIONS

This application is based on and claims priority from Japanese Patent Application No. 2023-119853, filed on Jul. 24, 2023, with the Japan Patent Office, the disclosure of which is incorporated herein in its entirety by reference.

### TECHNICAL FIELD

The present disclosure relates to a connector.

### BACKGROUND

Conventionally, a connector described in Japanese Patent Laid-open Publication No. 2018-006010 is known. This connector described is provided with a first housing and a second housing connectable to each other, a plurality of first terminal fittings to be arranged in the first housing and a shorting terminal arranged in the first housing to be brought into contact with short-circuit terminals, which are the first terminal fittings to be shorted. The shorting terminal includes contact pieces to be brought into contact with the short-circuit terminals. The contact pieces are deflectable and deformable in a vertical direction. The second housing includes a receptacle in the form of a rectangular tube projecting forward. A releasing portion is arranged to project in the receptacle. If the first and second housings are properly connected, the releasing portion interferes with front parts of the contact pieces of the shorting terminal and the contact pieces are deflected and deformed downward away from the short-circuit terminals. In this way, a short-circuit state of the short-circuit terminals is released.

### SUMMARY

In the above configuration, the contact pieces of the shorting terminal constantly continue to press the releasing portion toward the short-circuit terminals in a state where a short circuit of the short-circuit terminals is released by the releasing portion. Thus, the releasing portion may be deformed to approach the short-circuit terminals due to a creep phenomenon of a resin.

Accordingly, it is an object of the present invention to improve operability of a connector and connector assembly.

This object is solved according to the invention by the features of the independent claims. Particular embodiments of the invention are subject of the dependent claims.

One aspect is directed to a connector with a first housing and a second housing, a plurality of first terminals to be at least partly disposed in the first housing, and at least one shorting terminal to be disposed in the first housing, the shorting terminal including one or more contact pieces for shorting a pair of the first terminals, out of the plurality of first terminals, by resiliently contacting the pair of first terminals, and the second housing including at least one releasing projection substantially projecting in a connection direction to the first housing, the releasing projection including at least one releasing portion for releasing a short circuit of the pair of first terminals by resiliently deforming the contact piece(s) toward one side in a first direction when the first and second housings are properly connected, and one or more extending portions extending in a second direction intersecting with or substantially orthogonal to the first direction from the releasing portion.

According to a particular embodiment, the first housing including contact portions for contacting the extending portions from the other side in the first direction.

According to a particular embodiment, there is provided a connector being provided with a first housing and a second housing, a plurality of first terminals to be disposed in the first housing, and at least one shorting terminal to be disposed in the first housing, the shorting terminal including a pair of contact pieces for shorting a pair of the first terminals, out of the plurality of first terminals, by resiliently contacting the pair of first terminals, the second housing including a releasing projection projecting in a connection direction to the first housing, the releasing projection including a releasing portion for releasing a short circuit of the pair of first terminals by resiliently deforming one of the pair of contact pieces toward one side in a first direction when the first and second housings are properly connected, and extending portions extending toward both sides in a second direction intersecting with or substantially orthogonal to the first direction from the releasing portion, and the first housing including contact portions for contacting the extending portions from the other side in the first direction.

According to the above, since the contact portions contact the extending portions from the other side in the first direction, it can be suppressed that the releasing projection is deformed toward the other side in the first direction by a resilient pressing force of the contact piece.

Particularly, the releasing projection includes one or more ribs extending toward the one side in the first direction from the one or more extending portions.

Further particularly, the one or more ribs extend in the connection direction.

According to the above, the deformation of the releasing projection can be further suppressed by improving the strength of the extending portions by the one or more ribs.

Further particularly, the ribs include a first rib to be disposed between the pair of contact pieces and a second rib to be disposed on a side opposite to the first rib in the releasing projection.

Further particularly, the second rib is smaller than the first rib.

According to the above, a space for accommodating the second rib to be disposed outside the pair of contact pieces can be reduced.

Further particularly, the first housing includes a plurality of first cavities disposed substantially side by side in the second direction for at least partly accommodating the first terminals, a plurality of second cavities arranged substantially side by side in the second direction for at least partly accommodating the shorting terminal, at least one separation wall portion at least partly disposed between adjacent ones of the second cavities and at least one first wall portion at least partly disposed between adjacent ones of the first cavities and/or connected to the separation wall portion in the first direction, the separation wall portion has a first surface, a second surface disposed on a side opposite to the first surface and a recess recessed toward one side in the second direction from the second surface, the recess preferably is capable of at least partly accommodating the second rib, and/or the first surface preferably is connected to the first wall portion via at least one step surface and/or disposed further on the one side in the second direction than the first wall portion.

Further particularly, the first housing includes a plurality of first cavities disposed side by side in the second direction for accommodating the first terminals, a plurality of second cavities arranged side by side in the second direction for accommodating the shorting terminal, a separation wall portion disposed between adjacent ones of the second cavities and a first wall portion disposed between adjacent ones of the first cavities and connected to the separation wall portion in the first direction, the separation wall portion has a first surface, a second surface disposed on a side opposite to the first surface and a recess recessed toward one side in the second direction from the second surface, the recess is capable of accommodating the second rib, and the first surface is connected to the first wall portion via a step surface and disposed further on the one side in the second direction than the first wall portion.

According to the above, the recess for accommodating the second rib can be formed in the separation wall portion while a thickness of the separation wall portion is ensured.

Further particularly, the extending portions include a first extending portion with the first rib extending therefrom and/or a second extending portion with the second rib extending therefrom, the first extending portion is disposed to at least partly enter the first housing earlier than the releasing portion and/or the second extending portion when the first and second housings are connected, an inclined portion preferably is formed on a projecting end part of the first extending portion, and the inclined portion further preferably is inclined toward the one side in the first direction in a projection direction of the releasing projection.

Further particularly, the extending portions include a first extending portion with the first rib extending therefrom and a second extending portion with the second rib extending therefrom, the first extending portion is disposed to enter the first housing earlier than the releasing portion and the second extending portion when the first and second housings are connected, an inclined portion is formed on a projecting end part of the first extending portion, and the inclined portion is inclined toward the one side in the first direction in a projection direction of the releasing projection.

According to this configuration, the first extending portion hard to deform by including the thick first rib enters the first housing earlier than the releasing portion and the second extending portion. Further, the entrance of the first extending portion into the first housing is guided by the inclined portion. Therefore, even if the releasing projection is partially deformed toward the other side in the first direction due to stress from the contact piece, the first extending portion enters the first housing, whereby the releasing portion and the second extending portion also easily enter the first housing, following the first extending portion.

According to the above, the deformation of a releasing projection can be suppressed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view of a second housing of a connector according to an embodiment when viewed from behind.

FIG. 2 is a view of a releasing projection when viewed from above.

FIG. 3 is a view of the releasing projection when viewed from behind.

FIG. 4 is a perspective view of the releasing projection.

FIG. 5 is a view of a first housing of the connector when viewed from front.

FIG. 6 is a perspective view of the first housing.

FIG. 7 is a section along A-A of FIG. 5 showing a state before the first and second housings are connected.

FIG. 8 is a section along A-A of FIG. 5 showing a state where the first and second housings are properly connected.

FIG. 9 is an enlarged view of an essential part of FIG. 8.

FIG. 10 is a section along B-B of FIG. 9.

FIG. 11 is a section along C-C of FIG. 10.

FIG. 12 is an enlarged perspective view of a housing body and one shorting terminal accommodated in the housing body.

FIG. 13 is a perspective view of the shorting terminal.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

Hereinafter, an embodiment of the present disclosure is described. The present disclosure is not limited to these illustrations, but is represented by claims and intended to include all changes in the scope of claims and in the meaning and scope of equivalents. For the convenience of description, some components may be shown in an exaggerated or simplified manner in each drawing. Further, a dimension ratio of each part may be different in each figure. “Orthogonal” in this specification means not only strictly orthogonal, but also substantially orthogonal within a range in which functions and effects in the embodiment are achieved.

Further, “facing each other” in this specification indicates that surfaces or members are at positions in front of each other, and means not only a case where the surfaces or members are at positions perfectly in front of each other, but also a case where the surfaces or members are at positions partially substantially in front of each other. Further, “facing each other” in this specification means both a case where another member different from two parts at least partly is interposed between the two parts and a case where nothing is interposed between the two parts.

Further, a term “tubular” used in the description of this specification indicates not only a shape formed by a peripheral wall continuous over an entire periphery in a circumferential direction, but also a tubular shape formed by combining a plurality of components and a shape having a cut or the like in a circumferential part such as a C shape. Further, the “tubular” shapes include substantially circular shapes, substantially elliptical shapes and substantially polygonal shapes with angular and/or rounded corners.

### Embodiment

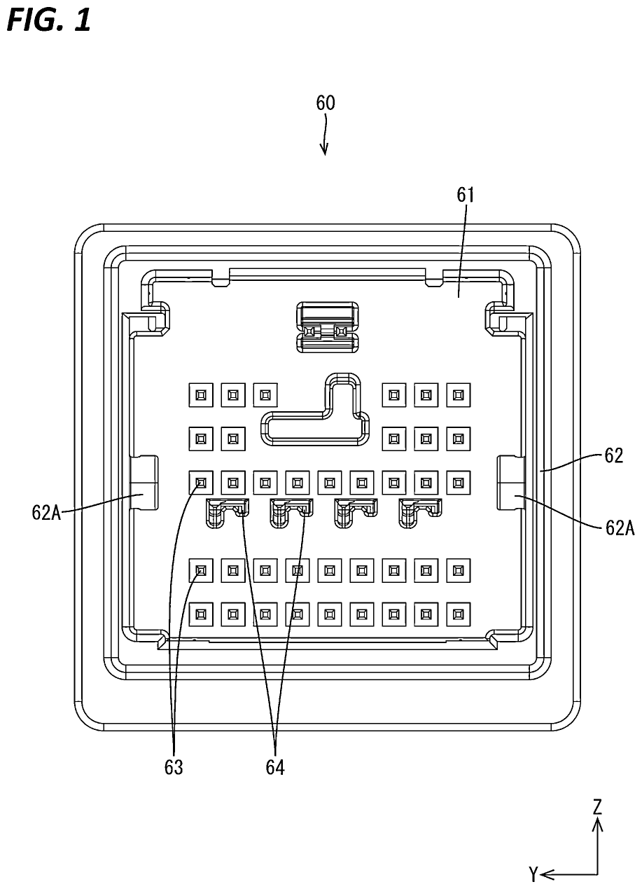

The embodiment of the present disclosure is described with reference to FIGS. 1 to 13. In the following description, a direction indicated by an arrow Z is referred to as an upward direction, a direction indicated by an arrow X is referred to as a forward direction and a direction indicated by an arrow Y is referred to as a leftward direction. A front-rear direction is an example of a connection direction. A lateral direction is an example of a second direction. A vertical direction is an example of a first direction. Note that, for a plurality of identical members, only some members may be denoted by a reference sign and the others may not be denoted by the reference sign.

### (Connector 10)

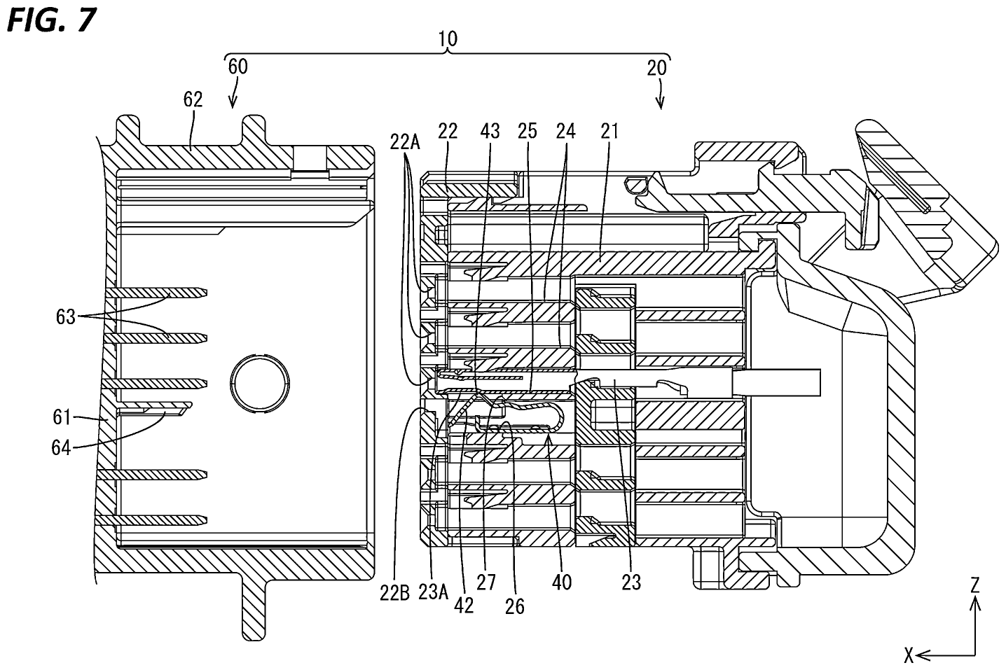

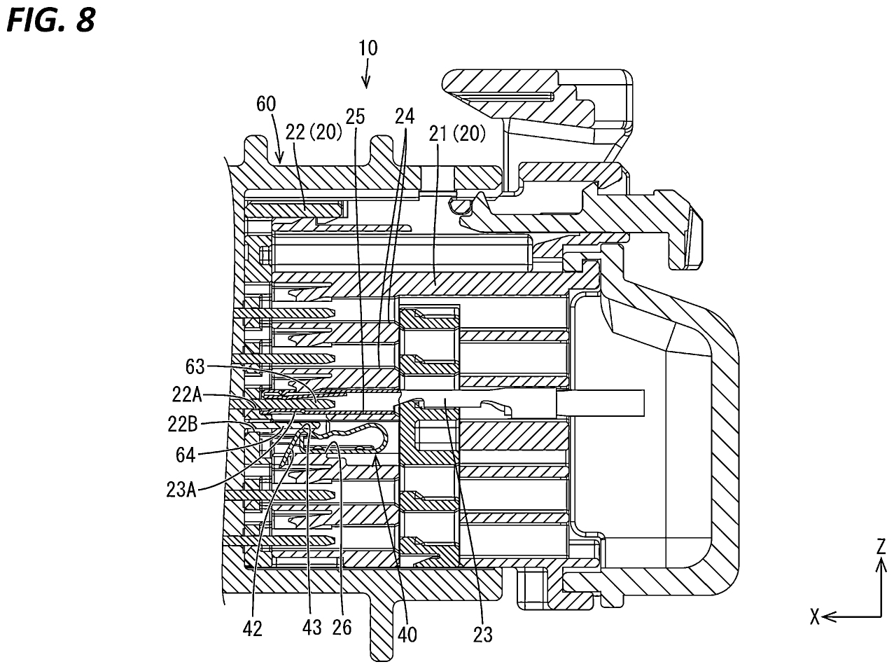

As shown in FIGS. 7 and 8, a connector 10 is provided with at least a first housing 20 and a second housing 60 connectable to and separable from each other.

In this embodiment, the configuration of the connector 10 is described, assuming that a direction of connecting the first and second housings 20, 60 is the front-rear direction and the first housing 20 particularly is disposed substantially behind the second housing 60.

### (First Housing 20)

The first housing 20 particularly is made of insulating synthetic resin.

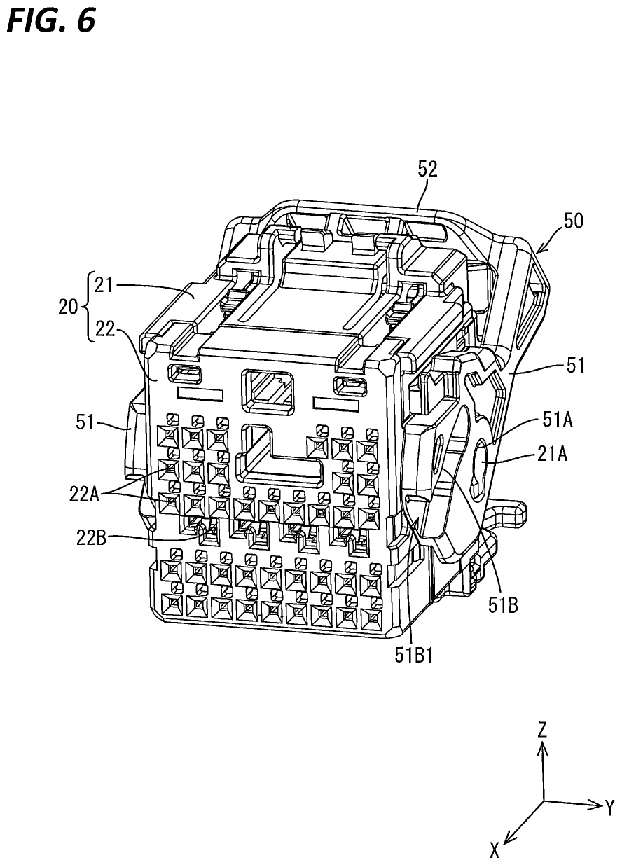

As shown in FIG. 6, the first housing 20 includes a (particularly substantially block-like) housing body 21 and/or a (particularly substantially flat plate-like) front holder 22 to be arranged to at least partly cover the front surface of the housing body 21.

As shown in FIGS. 7 and 8, the housing body 21 includes a plurality of cavities 24 capable of accommodating first terminals 23. Each cavity 24 particularly substantially is formed to penetrate through the housing body 21 in the front-rear direction.

The plurality of cavities 24 are arranged side by side in the lateral direction in one or more, particularly a plurality of stages in the vertical direction.

The first terminal 23 particularly is formed, such as by bending, folding, cutting and/or embossing an electrically conductive (particularly metal) plate material.

The first terminal 23 particularly is a female terminal and includes a substantially tubular connecting tube portion 23A in a front end part. Note that only the first terminal 23 accommodated in one of the plurality of cavities 24 is shown in FIGS. 7 and 8.

Specifically, out of the plurality of cavities 24, those arranged in the third stage from above particularly are a plurality of first cavities 25.

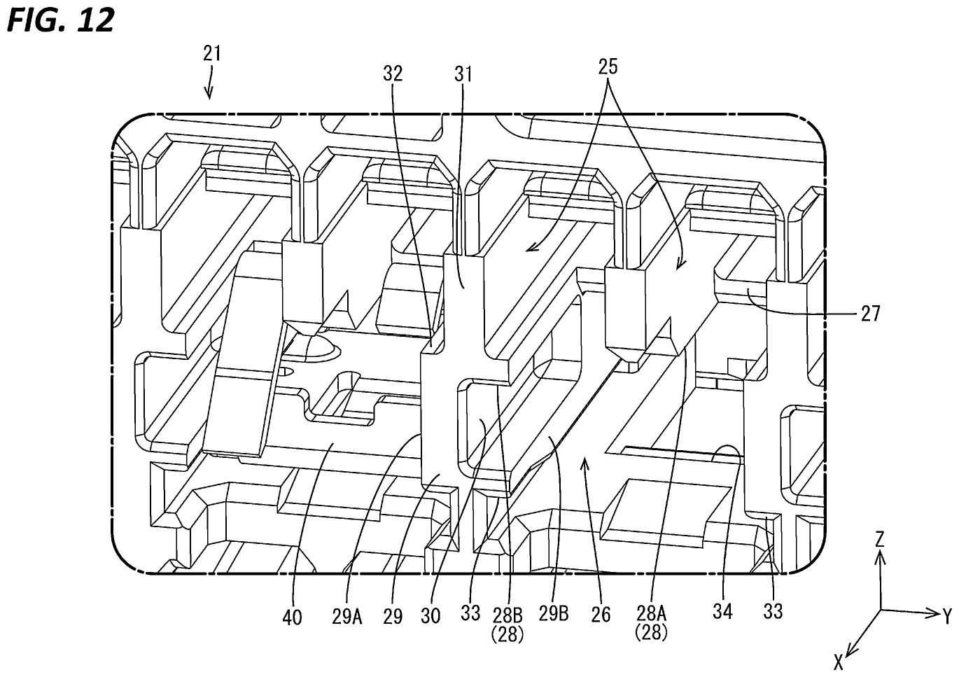

As shown in FIG. 12, a plurality of second cavities 26 particularly are formed adjacent to (e.g. below) the plurality of the first cavities 25 in the housing body 21.

The plurality of second cavities 26 particularly are arranged substantially side by side in the lateral direction.

Specifically, at least part, particularly each second cavity 26 is disposed adjacent to (e.g. below) a pair of the first cavities 25 adjacent in the lateral direction and/or at least partly communicates with the pair of first cavities 25.

In particular, a communication recess 27 allowing communication between the first cavity 25 and the second cavity 26 is formed in the adjacent surface (e.g. the lower surface) of the inner wall of each of the pair of first cavities 25. The communication recess 27 particularly is recessed rearward from the front surface of the housing body 21.

### (Contact Portions 28)

A first contact portion 28A is formed in a lateral intermediate or central part of the neighboring surface (e.g. upper surface) of the inner wall of the second cavity 26.

Specifically, the first contact portion 28A at least partly is disposed between two communication recesses 27.

The first contact portion 28A and a second contact portion 28B to be described next particularly constitute or form part of contact portions 28.

The second cavities 26 adjacent in the lateral direction particularly at least partly are separated by one or more separation wall portions 29. The separation wall portion 29 particularly is thin in the lateral direction and/or particularly extends substantially in the vertical direction and front-rear direction.

Specifically, the separation wall portion 29 has a first surface 29A and a second surface 29B disposed on a side substantially opposite to the first surface 29A. The first surface 29A particularly is a surface on a right side of the separation wall portion 29 and a left side surface of the inner wall of the second cavity 26. The second surface 29B particularly is a surface on a left side of the separation wall portion 29 and a right side surface of the inner wall of the second cavity 26.

The separation wall portion 29 particularly includes at least one recess 30 recessed laterally e.g. rightward (as an example of one side in the second direction) from the second surface 29B.

Out of the inner surface of the recess 30, a surface disposed on an upper side particularly serves as the second contact portion 28B.

The inner wall of the first cavity 25 particularly includes a first wall portion 31 connected to the separation wall portion 29 particularly substantially in the vertical direction. The first wall portion 31 particularly at least partly separates the first cavities 25 adjacent in the lateral direction.

Specifically, a pair of the first cavities 25 are disposed between two first wall portions 31 closest to each other in the lateral direction. The first surface 29A of the separation wall portion 29 particularly is connected to the first wall portion 31 specifically via at least one step surface 32 and/or disposed laterally of (e.g. to the right of) the first wall portion 31. The step surface 32 particularly is a part of the lower surface of the inner wall of the first cavity 25.

By particularly connecting the first surface 29A and the first wall portion 31 e.g. via a step in this way, the recess 30 can be formed while a thickness of the separation wall portion 29 is ensured. In other words, the strength of the separation wall portion 29 can be maintained even if the recess 30 is formed.

The second cavity 26 particularly is formed with one or more entrance recesses 33 recessed from (particularly both side surfaces of) the inner wall of the second cavity 26. The one or more entrance recesses 33 particularly are disposed in lower parts of the both side surfaces of the inner wall of the second cavity 26.

Further, at least one lock receiving portion 34 particularly is formed on (particularly the lower surface of) the inner wall of the second cavity 26.

A shorting terminal 40 at least partly is to be accommodated in the second cavity 26.

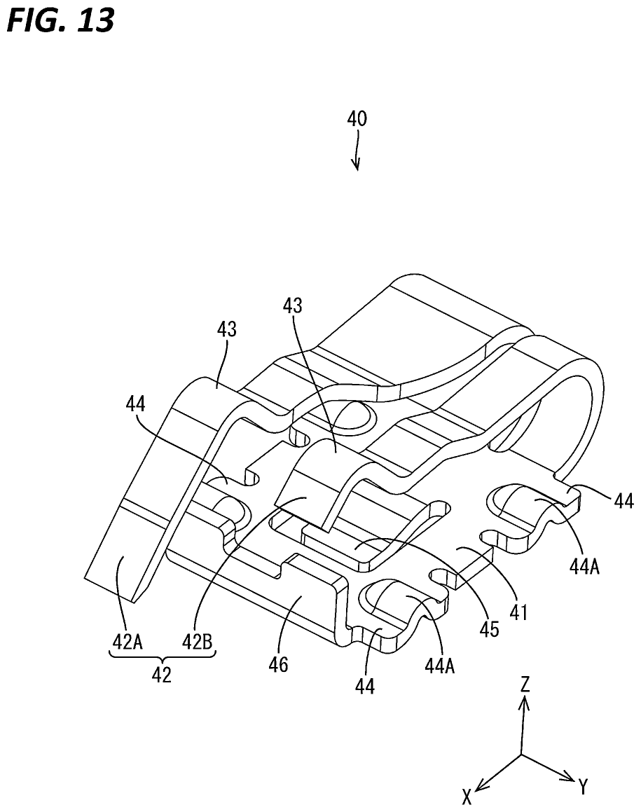

Specifically, as shown in FIG. 13, the shorting terminal 40 is formed, such as by cutting, recessing, folding, bending and/or embossing an electrically conductive (particularly metal) plate material.

The shorting terminal 40 particularly includes a base or bottom plate portion 41 (particularly substantially in the form of a flat plate) and one or more, particularly a pair of contact pieces 42 substantially extending from the base or bottom plate portion 41.

Specifically, the one or more, particularly the pair of contact pieces 42 substantially extend forward after being curved upward from (particularly both sides in a width direction (lateral direction) of the rear end of) the bottom plate portion 41.

The (particularly each) contact piece 42 is configured to be resiliently deformable.

Specifically, a contact point portion 43 particularly having a chevron shape and/or projecting outward or upward is formed on or near a front part of each contact piece 42.

As shown in FIG. 7, the one or more contact point portions 43 of the one or more, particularly the pair of, contact pieces 42 at least partly enter the first cavities 25 through the at least one communication recess 27 and/or contact the lateral (e.g. lower) surfaces of the corresponding connecting tube portions 23A of a pair of the first terminals 23.

The pair of first terminals 23 are to be maintained in a short-circuit state via the one or more, particularly the pair of, contact pieces 42 of the shorting terminal 40.

Specifically, as shown in FIG. 13, the pair of contact pieces 42 are composed of or comprise a first contact piece 42A and a second contact piece 42B. The first contact piece 42A is disposed laterally of (e.g. to the right of) the second contact piece 42B.

A rear part (particularly substantially a rear half) of the first contact piece 42A is formed to be wider than a front part (particularly substantially a front half) thereof. Specifically, the second contact piece 42B is formed to have substantially the same width as the front part (particularly the front half) of the first contact piece 42A, and/or the width thereof substantially is constant.

According to this configuration, the plastic deformation of the first contact piece 42A particularly can be suppressed when stress is continuously applied to the first contact piece 42A substantially along a deflection direction e.g. in the vertical direction.

The first and second contact pieces 42A, 42B particularly include the contact point portions 43 at the substantially same position in the front-rear direction, but the front end of the second contact piece 42B particularly is located rearward of that of the first contact piece 42A. In other words, the second contact piece 42B is shorter than the first contact piece 42A.

The shorting terminal 40 particularly includes one or more locking pieces 44 protruding laterally from one or both end edges of the base or bottom plate portion 41 and/or at least one locking portion 45 projecting outwardly (e.g. downward) from the bottom plate portion 41.

Specifically, the locking piece 44 is formed with at least one locking protrusion 44A projecting (e.g. upward) from the base or bottom plate portion 41.

The locking portion 45 particularly is formed by cutting and raising or embossing the base or bottom plate portion 41.

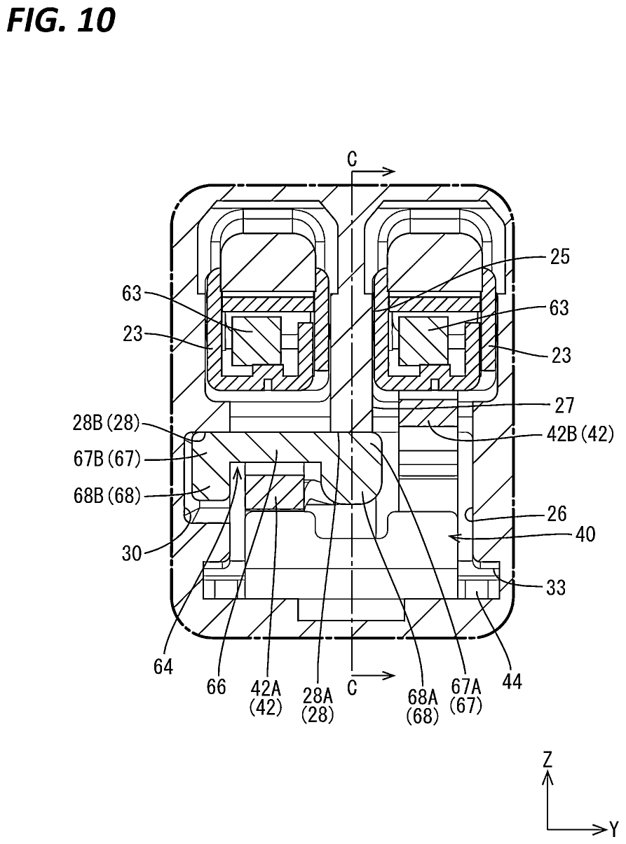

As shown in FIG. 10, the locking pieces 44 particularly are to be press-fit into the entrance recesses 33.

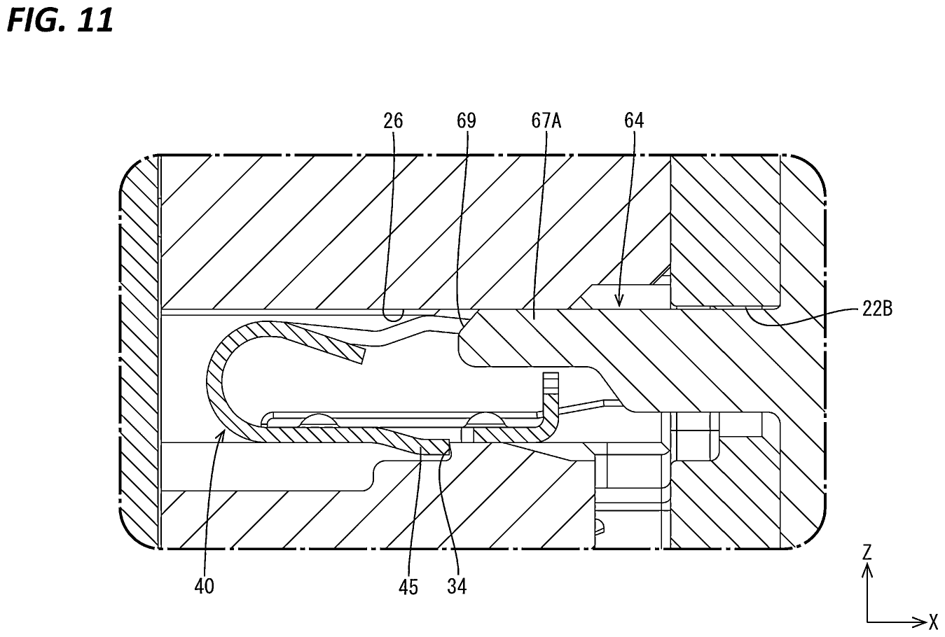

As shown in FIG. 11, the locking portion 45 particularly is locked to the lock receiving portion 34 in the front-rear direction.

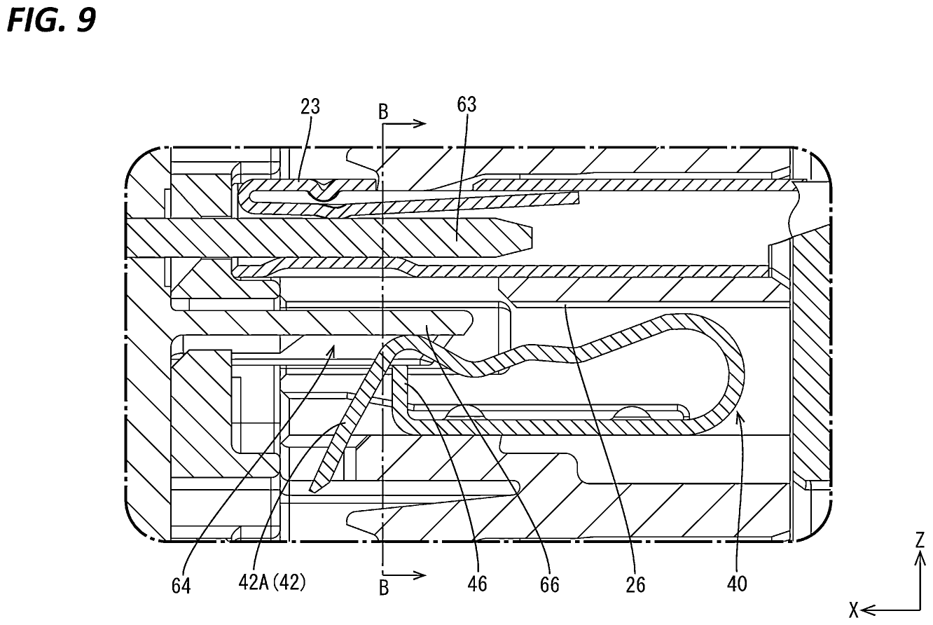

As shown in FIG. 13, at least one restricting piece 46 particularly is provided to rise upward on or near the front end of the base or bottom plate portion 41. Specifically, the at least one restricting piece 46 contacts or can contact the contact piece(s) 42 from a deflection side (e.g. from below), whereby the contact piece(s) 42 can be suppressed from being excessively deflected and deformed in a deflection direction e.g. downward (see FIG. 9).

The front holder 22 is to be assembled with the housing body 21, for example, by being slid (e.g. in the vertical direction) substantially along the front surface of the housing body 21.

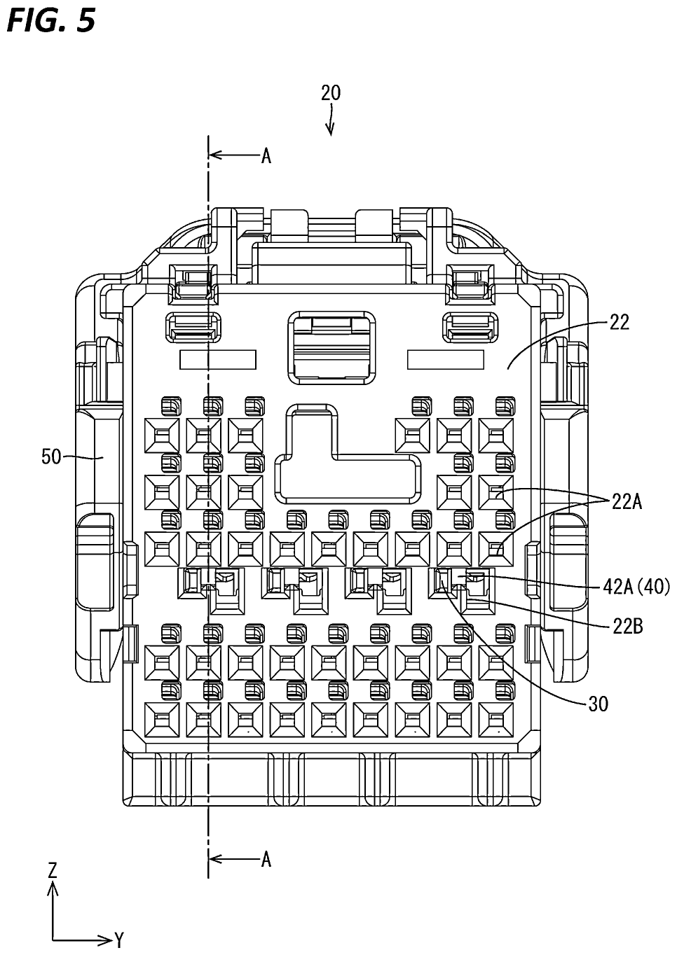

As shown in FIGS. 5 and 6, tab insertion holes 22A and one or more releasing holes 22B are provided to penetrate through the front holder 22.

The tab insertion holes 22A particularly substantially are disposed at positions facing or corresponding to the respective cavities 24, into which the first terminals 23 at least partly are to be inserted.

An opening edge part of the tab insertion hole 22A in the front surface of the front holder 22 particularly at least partly is tapered and/or expanded forward.

As shown in FIG. 8, a second terminal 63 particularly at least partly is to be inserted into the tab insertion hole 22A substantially from front at the time of connecting the first and second housings 20, 60.

The one or more releasing holes 22B particularly are disposed at positions facing or corresponding to the respective second cavities 26.

As shown in FIG. 5, the releasing hole 22B particularly at least partly exposes the first contact piece 42A of the shorting terminal 40 accommodated in the second cavity 26 substantially forward.

The second contact piece 42B of the shorting terminal 40 at least partly accommodated in the second cavity 26 particularly at least partly is covered from front by the front holder 22 and particularly substantially not exposed from the releasing hole 22B.

Further, the releasing hole 22B particularly at least partly exposes the recess 30 forward.

As shown in FIG. 8, a releasing projection 64 of the second housing 60 to be described later particularly at least partly is insertable into the releasing hole 22B. Specifically, the releasing hole 22B has a cross-sectional shape substantially corresponding to the releasing projection 64.

An opening edge part of the releasing hole 22B particularly at least partly is tapered and/or expanded forward except at an upper part thereof.

As shown in FIG. 6, the housing body 21 particularly includes one or more rotary shafts 21A projecting outward in the lateral direction from respective side surface(s) of the housing body 21. The rotary shaft 21A particularly has a substantially cylindrical shape.

Specifically, the lever 50 is movably (particularly rotatably or pivotably) supported on the housing body 21 e.g. by the rotary shafts 21A.

The lever 50 particularly is made of insulating synthetic resin.

Specifically, the lever 50 is substantially U-shaped as a whole. The lever 50 includes one or more, particularly two plate-like portions 51 and an operating portion 52 connected to the plate-like portion(s) 51, e.g. connecting end parts of the pair of plate-like portions 51. The two plate-like portions 51 particularly are disposed to substantially face each other.

The plate-like portion 51 particularly is formed with a shaft hole 51A penetrating through the plate-like portion 51 and at least one cam groove 51B penetrating or recessed in a thickness direction (lateral direction) of the plate-like portion 51 (e.g. from the outer surface of the plate-like portion 51).

The cam groove 51B particularly includes an entrance opening 51B1 in an outer edge part of the plate-like portion 51, and/or extends in a substantially arcuate manner from the entrance opening 51B1 to approach the shaft hole 51A.

### (Second Housing 60)

The second housing 60 particularly is made of insulating synthetic resin.

Specifically, as shown in FIG. 7, the second housing 60 includes a back wall 61 and a peripheral wall 62 extending toward the first housing 20 (rearward) from (particularly an outer peripheral edge part of) the back wall 61.

The second housing 60 particularly substantially is open rearward.

The second housing 60 particularly is to be connected to the first housing 20 substantially from outside (see FIG. 8).

Further specifically, as shown in FIG. 1, each of a pair of wall portions disposed on both left and right sides, out of the peripheral wall 62, is formed with at least one cam pin 62A projecting inwardly of the second housing 60 from the inner surface thereof. The cam pin 62A particularly has a substantially cylindrical shape.

The cam pin 62A at least partly enters the cam groove 51B through the entrance opening 51B1 provided in the lever 50. By displacing (e.g. rotating or pivoting) the lever 50 with the cam pin(s) 62A disposed inside the cam groove(s) 51B and the cam pin(s) 62A and the inner wall(s) of the cam groove(s) 51B engaged, the connection/separation of the first and second housings 20, 60 is assisted or performed particularly by a cam action displayed by the cam pin(s) 62A and the cam groove(s) 51B.

As shown in FIG. 7, the second terminals 63 particularly at least partly are arranged in the second housing 60.

The second terminal 63 particularly is made of electrically conductive material such as metal. Specifically, the second terminal 63 is a male terminal and substantially tab-like.

The second terminal 63 particularly is held through the back wall 61 and/or particularly projects substantially rearward in the second housing 60.

Specifically, as shown in FIG. 8, if the first and second housings 20, 60 are properly connected, the second terminal 63 at least partly is disposed in the connecting tube portion 23A of the first terminal 23, whereby the first and second terminals 23, 63 are electrically connected.

### (Releasing Projection 64, Releasing Portion 66, Extending Portions 67)

As shown in FIG. 7, the second housing 60 particularly includes the releasing projection 64 e.g. substantially projecting rearward from the back wall 61.

The releasing projection 64 particularly is cantilevered from the back wall 61 and/or integrally formed to the second housing 60.

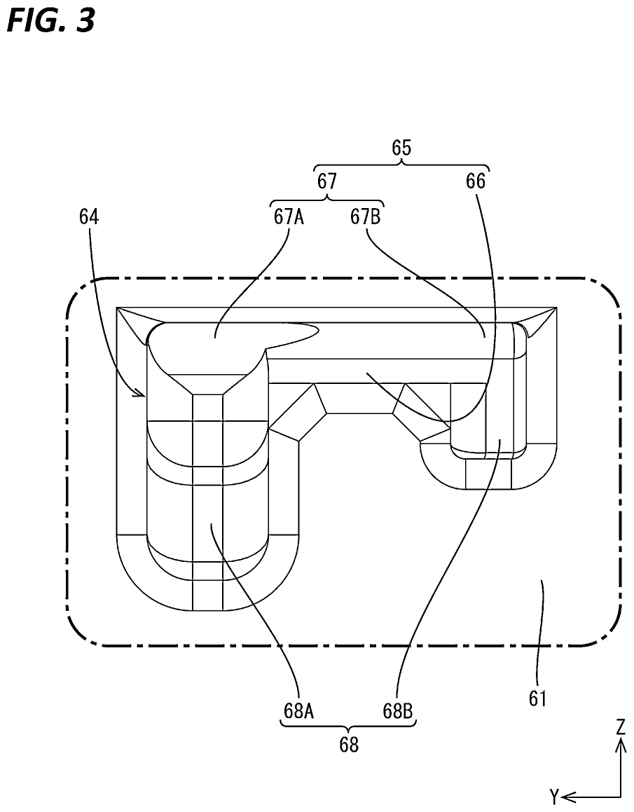

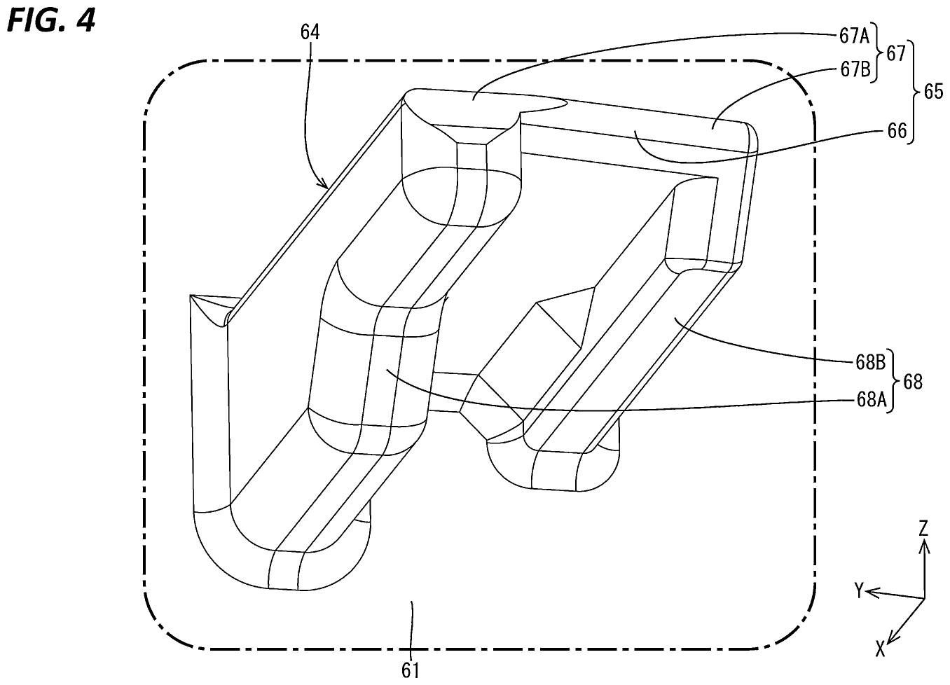

Specifically, as shown in FIGS. 3 and 4, the releasing projection 64 includes a body portion 65 particularly substantially in the form of a plate thin in the vertical direction and/or one or more ribs 68 extending downward (an example of one side in the first direction) from (particularly one or both left and right end parts of) the body portion 65.

The body portion 65 particularly is composed of or comprises at least one releasing portion 66 and one or more extending portions 67. The releasing portion 66 particularly is a part disposed substantially at a center position of the body portion 65 in the lateral direction.

Specifically, the one or more extending portions 67 extend toward one or both lateral (left and/or right) sides from the releasing portion 66. The extending portions 67 particularly are composed of or comprise a first extending portion 67A substantially extending laterally (e.g. leftward) from the releasing portion 66 and/or a second extending portion 67B substantially extending laterally (e.g. rightward) from the releasing portion 66.

### (Ribs 68)

The one or more ribs 68 particularly are composed of or comprise a first rib 68A extending downward from the first extending portion 67A and/or a second rib 68B extending downward from the second extending portion 67B.

Specifically, as shown in FIG. 4, the first and second ribs 68A, 68B substantially extend in the front-rear direction and/or are directly connected to the back wall 61.

A part (particularly front half) of the first rib 68A near the back wall 61 particularly has a larger extension dimension from the first extending portion 67A than a part (particularly rear half) thereof on a side opposite to the back wall 61.

The second rib 68B particularly is formed to be smaller than the first rib 68A. In particular, a lateral dimension of the second rib 68B substantially is smaller than that of the first rib 68A. Further particularly, a vertical dimension of the second rib 68B substantially is smaller than that of the first rib 68A.

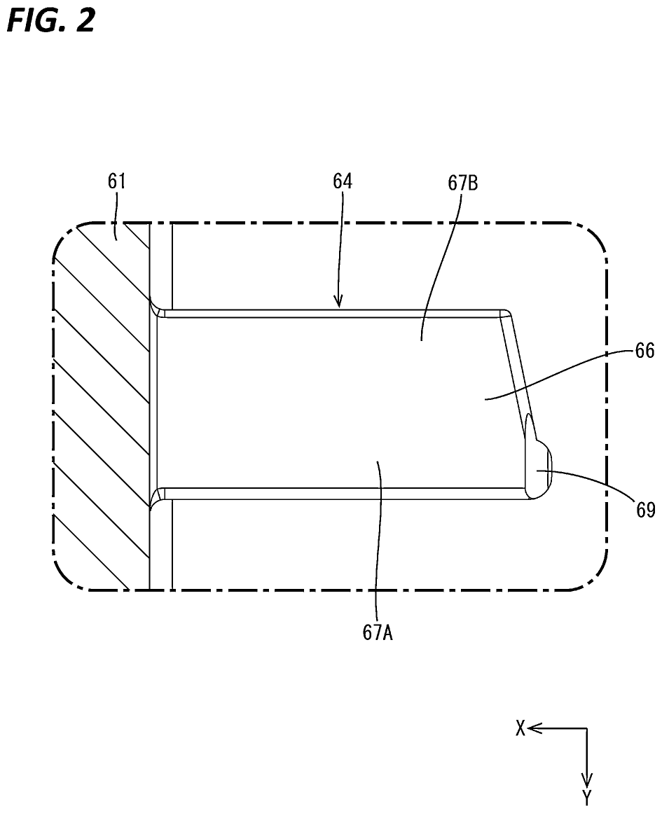

Specifically, as shown in FIG. 2, the first extending portion 67A is longer in the front-rear direction than the releasing portion 66 and/or the second extending portion 67B. That is, a projecting end part (e.g. rear end part) of the first extending portion 67A particularly is disposed further in a projection direction of the releasing projection 64 (rearward) than that of the releasing portion 66 and that of the second extending portion 67B.

Further particularly, at least one inclined portion 69 is formed on the upper surface of (particularly the projecting end part of) the first extending portion 67A. As shown in FIG. 11, the inclined portion 69 particularly is inclined downward toward a rear side.

### (Function of Releasing Projection 64)

The connector 10 of this embodiment is used, for example, in an airbag circuit of an automotive vehicle. As shown in FIG. 7, with the first and second housings 20, 60 separated (unconnected), the pair of contact pieces 42 resiliently contact the lateral (e.g. lower) surfaces of (particularly the connecting tube portions 23A of) the pair of first terminals 23 and the pair of first terminals 23 are kept in a short-circuit state by the shorting terminal 40. In this way, accidental explosion of the airbag is prevented.

As shown in FIG. 8, with the first and second housings 20, 60 properly connected, a short circuit of the pair of first terminals 23 is released and the airbag enters a normal operable state.

If the first and second housings 20, 60 are connected, the releasing projection 64 particularly at least partly enters the second cavity 26 through the releasing hole 22B.

Specifically, the releasing portion 66 at least partly enters deep into the second cavity 26 while substantially sliding in contact with the first contact piece 42A. In this way, the first contact piece 42A is resiliently deformed in the deformation direction (e.g. downward) and the contact of the first contact piece 42A and the first terminal 23 is released (see FIGS. 9 and 10). As a result, the short circuit of the pair of first terminals 23 is released.

With the short circuit of the pair of first terminals 23 released, the releasing portion 66 particularly at least partly is interposed between the first contact piece 42A and the first terminal 23.

An upward resilient pressing force (biasing force) due to a resilient restoring force of the first contact piece 42A particularly is constantly applied to the releasing portion 66 e.g. from below. Thus, if the first and second housings 20, 60 are connected over a long period of time, the releasing projection 64 made of synthetic resin may be deformed to warp upward e.g. due to a creep phenomenon of the resin.

In this embodiment, to suppress the deformation of the releasing projection 64 described above, the one or more extending portions 67 are provided on (particularly one or both lateral (left and/or right) sides of) the releasing portion 66 and the one or more contact portions 28 are provided in the second cavity 26 of the first housing 20.

Specifically, with the first and second housings 20, 60 properly connected, the one or more contact portions 28 are disposed to be able to contact the one or more extending portions 67 e.g. from above (an example of the other side in the first direction) as shown in FIG. 10. In particular, the first extending portion 67A and the first rib 68A are disposed between the pair of contact pieces 42.

The first contact portion 28A particularly is disposed to be able to contact the first extending portion 67A.

The second extending portion 67B and the second rib 68B particularly at least partly are accommodated in the recess 30.

The second contact portion 28B particularly is disposed to be able to contact the second extending portion 67B.

According to this embodiment, since the one or more contact portions 28 contact the one or more extending portions 67 disposed (particularly on the one or both lateral (left and/or right) sides of) the releasing portion 66, which receives a resilient pressing force of the first contact piece 42A, e.g. from above, the releasing projection 64 can be suppressed from being deformed (e.g. upward) by the resilient pressing force of the contact piece 42.

Further, the first extending portion 67A particularly is reinforced by the first rib 68A, and/or the second extending portion 67B particularly is reinforced by the second rib 68B. That is, the strength of the extending portions 67 is improved by providing the one or more ribs 68. In this way, the deformation of the releasing projection 64 can be further suppressed.

In this embodiment, with the first and second housings 20, 60 properly connected, the first rib 68A particularly at least partly is arranged between the pair of contact pieces 42 at a position near a central part of the second cavity 26.

The first rib 68A particularly is formed in such a size as to be at least partly fittable into a space between the pair of contact pieces 42.

Specifically, the second rib 68B is disposed to laterally (e.g. the right) of the first contact piece 42A and/or at least partly accommodated in the recess 30 provided in the lateral (e.g. right side) surface of the inner wall of the second cavity 26.

Since the second rib 68B particularly is formed to be smaller than the first rib 68A, a depth of the recess 30 can be reduced.

Thus, the thickness of the inner wall (separation wall portion 29) of the second cavity 26 is easily ensured.

Specifically, since the projecting end part of the first extending portion 67A is disposed on the furthest end of the releasing projection 64 in the projection direction (see FIG. 2), the first extending portion 67A, out of the releasing projection 64, first at least partly enters the second cavity 26 through the releasing hole 22B in the process of connecting the second housing 60 to the first housing 20.

Since particularly being reinforced by the first rib 68A, the first extending portion 67A is harder to deform than the releasing portion 66.

Further particularly, since the first rib 68A is thicker than the second rib 68B, the first extending portion 67A is harder to deform than the second extending portion 67B.

Thus, even if the releasing projection 64 is deformed e.g. upward, a corresponding (e.g. upward) deformation of the first extending portion 67A is thought to be relatively small in the releasing projection 64.

Since the first extending portion 67A particularly hard to deform in the releasing projection 64 particularly first at least partly enters the second cavity 26, the releasing portion 66 and the second extending portion 67B also easily at least partly enter the second cavity 26, following the first extending portion 67A.

Further particularly, since the inclined portion 69 is provided on the upper surface of the first extending portion 67A, the entrance of the releasing projection 64 into the second cavity 26 particularly substantially is guided by the sliding contact of the inclined portion 69 with the upper surface of the inner wall of the releasing hole 22B and/or the upper surface of the inner wall of the second cavity 26 even if the first extending portion 67A is slightly deformed upward (see FIG. 11).

As described above, in this embodiment, the deformation of the releasing projection 64 particularly is suppressed and/or the entrance of the releasing projection 64 into the second cavity 26 particularly substantially is guided.

Therefore, when the first and second housings 20, 60, which have been properly connected for a long period of time, are connected again after being temporarily separated, for example, at the time of maintenance of an automotive vehicle or the like, it is suppressed that the releasing projection 64 cannot enter the second cavity 26.

### Functions and Effects of Embodiment

The connector 10 according to the embodiment is provided with the first and second housings 20, 60, the plurality of first terminals 23 to be disposed in the first housing 20 and at least one shorting terminal 40 particularly to be disposed in the first housing 20.

The shorting terminal 40 includes the one or more, particularly the pair of contact pieces 42 for shorting the pair of first terminals 23 by resiliently contacting the pair of first terminals 23, out of the plurality of first terminals 23.

The second housing 60 particularly includes the releasing projection 64 substantially projecting in the connection direction to the first housing 20.

The releasing projection 64 particularly includes the at least one releasing portion 66 for releasing the short circuit of the pair of first terminals 23 by resiliently deforming part of the shorting terminal, e.g. by deforming one (first contact piece 42A) of the pair of contact pieces 42 toward the one side in the first direction (e.g. lower side) when the first and second housings 20, 60 are properly connected.

The releasing projection 64 particularly includes the one or more extending portions 67 substantially extending toward one or both sides in the second direction (lateral direction) intersecting or orthogonal to the first direction from the releasing portion 66.

Specifically, the first housing 20 includes the one or more contact portions 28 for contacting the one or more extending portions 67 from the other side (upper side) in the first direction.

According to the above, since the one or more contact portions 28 particularly contact the one or more extending portions 67 from the other side in the second direction, it can be suppressed that the releasing projection 64 is deformed toward the other side in the first direction by a resilient pressing force of the contact piece 42.

In the particular embodiment, the releasing projection 64 includes the one or more ribs 68 substantially extending toward the one side in the first direction from the one or more extending portions 67 and/or the one or more ribs 68 substantially extend in the connection direction.

According to this configuration, the strength of the extending portion(s) 67 can be improved by the rib(s) 68 and the deformation of the releasing projection 64 particularly can be further suppressed.

In the particular embodiment, the one or more ribs 68 include the first rib 68A to be at least partly disposed between the pair of contact pieces 42 and/or the second rib 68B to be at least partly disposed on the side of the releasing projection 64 particularly opposite to the first rib 68A.

Specifically, the second rib 68B is smaller than the first rib 68A.

According to the above, a space for accommodating the second rib 68B to be disposed outside the pair of contact pieces 42 can be reduced.

In the particular embodiment, the first housing 20 includes the plurality of first cavities 25 disposed substantially side by side in the second direction for at least partly accommodating the first terminals 23, the one or more, particularly the plurality of second cavities 26 (particularly disposed substantially side by side in the second direction) for at last partly accommodating the shorting terminal 40.

Specifically, the separation wall portion 29 disposed between adjacent one(s) of the second cavitie(s) 26, and the first wall portion 31 disposed between adjacent ones of the first cavities 25 and/or connected to the separation wall portion 29 in the first direction.

The separation wall portion 29 particularly has the first surface 29A, the second surface 29B particularly disposed on the side opposite to the first surface 29A, and the recess 30 recessed toward the one side in the second direction (right side) from the second surface 29B.

The recess 30 particularly can at least partly accommodate the second rib 68B.

The first surface 29A particularly is connected to the first wall portion 31 via the at least one step surface 32 and/or disposed further on the one side in the second direction than the first wall portion 31.

According to the above, the recess 30 for at least partly accommodating the second rib 68B can be formed in the separation wall portion 29 while the thickness of the separation wall portion 29 is ensured.

In this particular embodiment, the one or more extending portions 67 particularly include the first extending portion 67 with the first rib 68A extending therefrom and/or the second extending portion 67B with the second rib 68B extending therefrom.

The first extending portion 67A particularly is disposed to at least partly enter the first housing 20 earlier than the releasing portion 66 and/or the second extending portion 67B when the first and second housings 20, 60 are connected.

Particularly, the inclined portion 69 is formed on or near the projecting end part of the first extending portion 67A, and/or the inclined portion 69 particularly is inclined toward the one side in the first direction in the projection direction of the releasing projection 64.

According to the above, the first extending portion 67A hard to deform by including the thick first rib 68A at least partly enters the first housing 20 earlier than the releasing portion 66 and the second extending portion 67B.

Further, the entrance of the first extending portion 67A into the first housing 20 particularly is guided by the inclined portion 69.

Therefore, even if the releasing projection 64 is partially deformed toward the other side in the first direction e.g. due to stress from the contact piece 42, the first extending portion 67A at least partly enters the first housing 20, whereby the releasing portion 66 and the second extending portion 67B also easily at least partly enter the first housing 20, following the first extending portion 67A.

Accordingly, to suppress the deformation of a releasing projection, there is disclosed a connector 10 which is provided with a first housing 20 and a second housing 60, a plurality of first terminals 23 to be at least partly disposed in the first housing 20, and at least one shorting terminal 40 to be disposed in the first housing 20. The shorting terminal 40 includes one or more, particularly a pair of contact pieces 42 for shorting a pair of the first terminals 23, out of the plurality of first terminals 23, by resiliently contacting the pair of first terminals 23.

The second housing 60 includes at least one releasing projection 64 substantially projecting in a connection direction to the first housing 20.

The releasing projection 64 includes at least one releasing portion 66 for releasing a short circuit of the pair of first terminals 23 by resiliently deforming the contact piece(s) 42, particularly by deforming one of the pair of contact pieces 42, toward one side in a first direction when the first and second housings 20, 60 are properly connected, and one or more extending portions 67 extending (particularly toward one or both sides) in a second direction intersecting with or substantially orthogonal to the first direction from the releasing portion 66.

The first housing 20 includes one or more contact portions 28 for contacting the extending portions 67 from the other side in the first direction.

### Other Embodiments

The above embodiment can be modified and carried out as follows. The above embodiment and the following modifications can be carried out in combination without technically contradicting each other.
Although the releasing projection 64 particularly includes the one or more ribs 68 in the above embodiment, the rib(s) may be omitted.
Although the lever 50 particularly is assembled with the first housing 20 in the above embodiment, the lever may not be provided.
Although the first housing 20 particularly includes the front holder 22 in the above embodiment, the front holder may be omitted.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a first housing and a second housing;
a plurality of first terminals to be at least partly disposed in the first housing; and
at least one shorting terminal to be disposed in the first housing,
the shorting terminal including one or more contact pieces for shorting a pair of the first terminals, out of the plurality of first terminals, by resiliently contacting the pair of first terminals,
the second housing including at least one releasing projection substantially projecting in a connection direction to the first housing, and
the releasing projection including at least one releasing portion for releasing a short circuit of the pair of first terminals by resiliently deforming the contact piece(s) toward one side in a first direction when the first and second housings are properly connected, and one or more extending portions extending in a second direction intersecting with or substantially orthogonal to the first direction from the releasing portion.

2. The connector according to claim 1, wherein the first housing including one or more contact portions for contacting the extending portions from the other side in the first direction.

3. The connector according to claim 1, wherein the extending portions extending toward both sides in a second direction intersecting with or substantially orthogonal to the first direction from the releasing portion.

4. The connector according to claim 1, wherein the releasing projection includes one or more ribs extending toward the one side in the first direction from the one or more extending portions.

5. The connector according to claim 4, wherein the one or more ribs substantially extend in the connection direction.

6. The connector according to claim 4, wherein the ribs include a first rib to be disposed between the pair of contact pieces and a second rib to be disposed on a side opposite to the first rib in the releasing projection.

7. The connector according to claim 6, wherein the second rib is smaller than the first rib.

8. The connector according to claim 6, wherein:
the first housing includes a plurality of first cavities disposed substantially side by side in the second direction for at least partly accommodating the first terminals, a plurality of second cavities arranged substantially side by side in the second direction for at least partly accommodating the shorting terminal, at least one separation wall portion at least partly disposed between adjacent ones of the second cavities and at least one first wall portion at least partly disposed between adjacent ones of the first cavities and/or connected to the separation wall portion in the first direction,
the separation wall portion has a first surface, a second surface disposed on a side opposite to the first surface and a recess recessed toward one side in the second direction from the second surface,
the recess is capable of at least partly accommodating the second rib, and/or
the first surface is connected to the first wall portion via at least one step surface and/or disposed further on the one side in the second direction than the first wall portion.

9. The connector according to claim 6, wherein:
the extending portions include a first extending portion with the first rib extending therefrom and/or a second extending portion with the second rib extending therefrom,
the first extending portion is disposed to at least partly enter the first housing earlier than the releasing portion and/or the second extending portion when the first and second housings are connected,
an inclined portion is formed on a projecting end part of the first extending portion, and
the inclined portion is inclined toward the one side in the first direction in a projection direction of the releasing projection.
